(19) United States
(12) Patent Application Publication
(10) Pub. No.: US 2009/0294267 A1
(43) Pub. Date: Dec. 3, 2009

(54) LEVER SWITCH DEVICE

(75) Inventor: Keiji Misaka, Aichi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: KABUSHIKI KAISHA TOKAI RIKA DENKI SEISAKUSHO, Aichi (JP)

(21) Appl. No.: 12/476,867

(22) Filed: Jun. 2, 2009

(30) Foreign Application Priority Data
Jun. 3, 2008 (JP) 2008-145886

(51) Int. Cl. H01H 19/00

(52) U.S. Cl. 200/336

(57) ABSTRACT

A lever switch device, includes a lever main body comprising an insert hole communicating from a tip end portion to a terminal end portion and a first opening provided on a side surface so as to at least partially communicate with the insert hole between the tip end portion and the terminal end portion, the lever main body being rotatably supported by a body around a predetermined rotation center axis; and a first remote shaft rotatably arranged through the first opening of the lever main body, and comprising a first operating knob at one end portion and a first operation portion at another end portion for operating an operational object by a rotational operation of the first operating knob.

The present application is based on Japanese Patent Application No. 2008-145886 filed on Jun. 3, 2008, the entire contents of which are incorporated herein by reference.

### BACKGROUND OF THE INVENTION

1. Field of the Invention

The present invention relates to a lever switch device, in more particular, to a lever switch device applied to a vehicle such as an automobile, etc.

2. Related Art

An example of a lever switch device applied to a vehicle such as an automobile, etc. is configured to provide two operating knobs at a tip end portion of a lever which operates a turn signal switch. In the case of this configuration, the lever is rotatably provided on a body and, at the same time, two remote shafts operated by the two operating knobs are incorporated in the lever in a rotatable state. In addition, switches corresponding to the two operating knobs provided on the body are configured to carry out a switching operation by a rotation of the tip portions of the remote shafts according to a rotational operation of the operating knobs (e.g., JP-A 11-250772).

According to this lever switch device, since two rotationally operable operating knobs are provided in the lever, it is possible to simplify a structure in the lever and thereby realizing a lever switch for a vehicle having an operating lever with a slimmed shape. However, according to the lever switch device of JP-A 11-250772, since it is necessary to insert two remote shafts from a tip end portion of a lever in order to incorporate two remote shafts therein, there is a problem in that an attachment property is not good.

### THE SUMMARY OF THE INVENTION

It is an object of the invention to provide a lever switch device in that the attachment property is good and, furthermore, it is possible to reduce the number of components.

[1] According to a feature of the present invention, a lever switch device, comprising:

a lever main body comprising an insert hole communicating from a tip end portion to a terminal end portion and a first opening provided on a side surface so as to at least partially communicate with the insert hole between the tip end portion and the terminal end portion, the lever main body being rotatably supported by a body around a predetermined rotation center axis; and

a first remote shaft rotatably arranged through the first opening of the lever main body, and comprising a first operating knob at one end portion and a first operation portion at another end portion for operating an operational object by a rotational operation of the first operating knob.

[2] In the lever switch device described in above-mentioned [1], the first operating knob comprises a second opening for inserting the tip end portion of the lever main body and a first remote shaft supporting portion protruding from an inner wall of the second opening; and

the first remote shaft is rotatably supported with respect to the lever main body by the first remote shaft supporting portion.

[3] According to a feature of the present invention, a lever switch device, comprising:

a lever main body comprising an insert hole communicating from a tip end portion to a terminal end portion and a first opening provided on a side surface so as to at least partially communicate with the insert hole between the tip end portion and the terminal end portion, the lever main body being rotatably supported by a body around a predetermined rotation center axis;

a first remote shaft rotatably arranged through the first opening of the lever main body, and comprising a first operating knob at one end portion and a first operation portion at another end portion for operating an operational object by a rotational operation of the first operating knob, the first operating knob comprising a second opening for inserting the tip end portion of the lever main body and a first remote shaft supporting portion protruding from an inner wall of the second opening; and

a second remote shaft rotatably arranged in the insert hole of the lever main body having a coaxial structure with the first remote shaft, and comprising a second operating knob at one end portion and a second operation portion at another end portion for operating an operational object by a rotational operation of the second operating knob,

wherein first remote shaft is rotatably supported with respect to the lever main body by the first remote shaft supporting portion.

### EFFECT OF THE INVENTION

According to the invention, it is possible to provide a lever switch device in that the attachment property is good and, furthermore, it is possible to reduce the number of components.

### BRIEF DESCRIPTION OF THE DRAWINGS

Next, the present invention will be explained in more detail in conjunction with appended drawings, wherein:

FIG. 1 is an exploded perspective view showing a lever unit of a lever switch device in a preferred embodiment of the present invention;

FIG. 2 is a schematic view showing a first operating knob in the embodiment of the invention when viewed from a direction A of FIG. 1;

FIG. 3 is a cross sectional view showing the lever switch device in embodiment of the invention taken on line B-B of FIG. 1; and

FIG. 4 is a cross sectional view showing a lever main body including a rotation axis D in the embodiment of the invention taken on line G-G of FIG. 3.

### DESCRIPTION OF THE PREFERRED EMBODIMENTS

Next, preferred embodiments according to the present invention will be explained in conjunction with appended drawings.

### Embodiment of the Invention

### (Structure of Lever Switch Device 1)

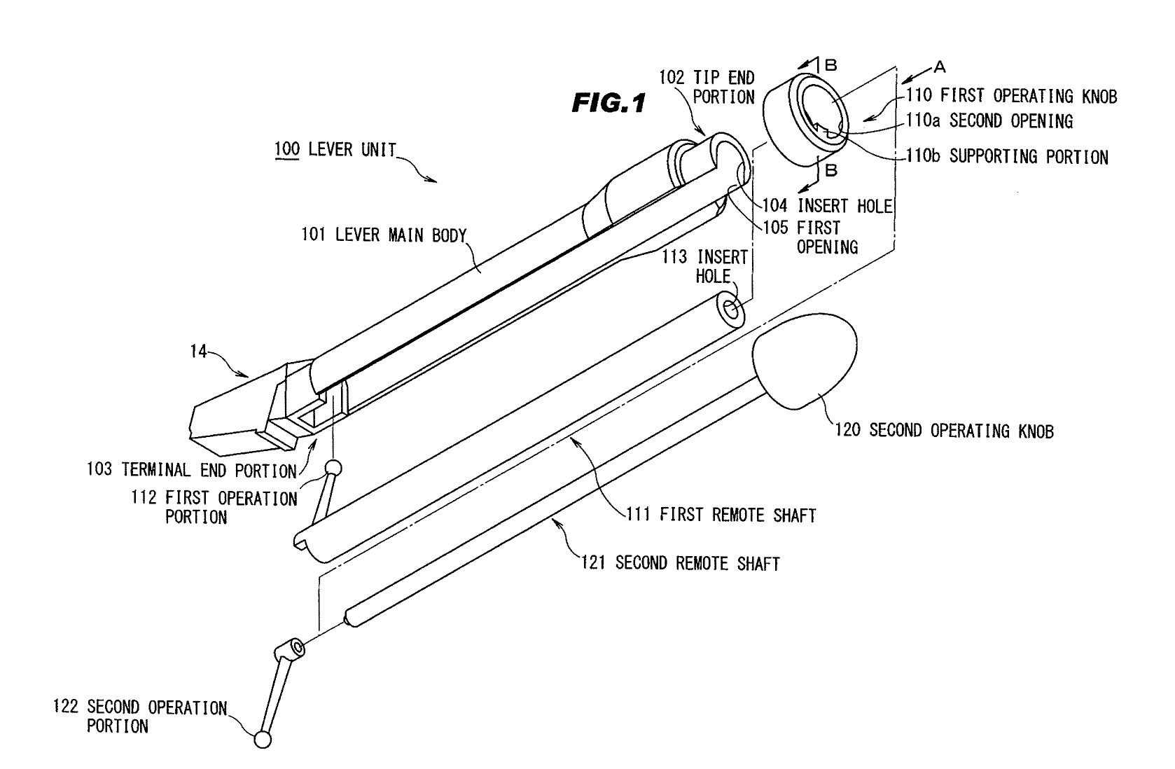

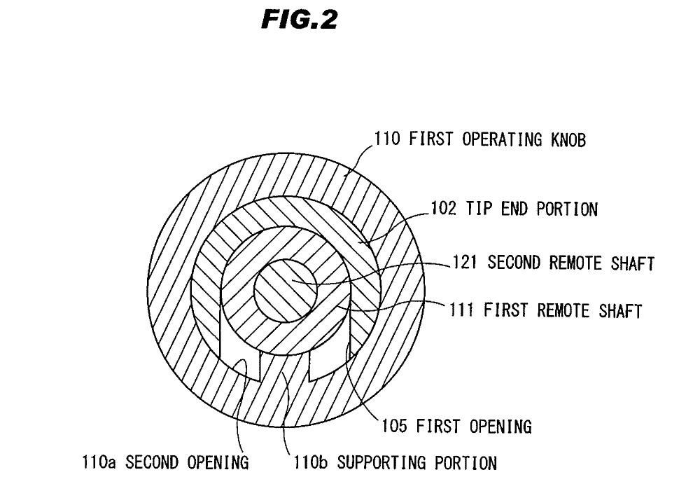

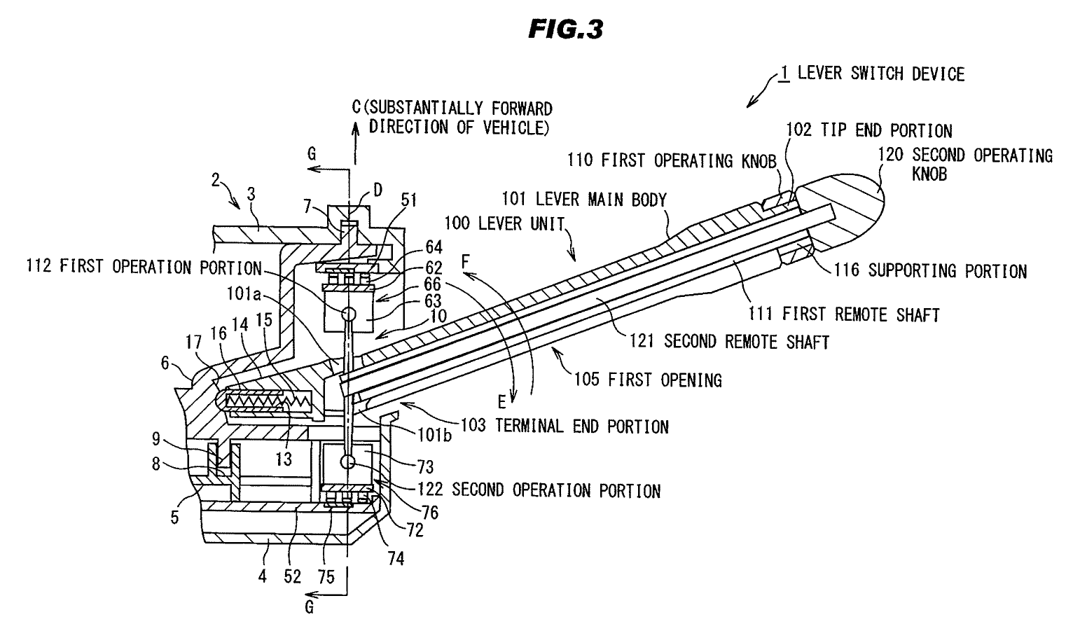

FIG. 1 is an exploded perspective view showing a lever unit of a lever switch device in a preferred embodiment of the present invention, FIG. 2 is a schematic view showing a first operating knob in the embodiment of the invention when viewed from a direction A of FIG. 1, and FIG. 3 is a cross sectional view showing the lever switch device in embodiment of the invention taken on line B-B of FIG. 1. It will be explained that a lever switch device 1 of the invention is provided at a peripheral portion of a steering column of a non-illustrated vehicle. In addition, a direction C in FIG. 3 is a substantially forward direction of the vehicle, hence, FIG. 1 is a cross sectional view showing a lever switch device when viewed from a substantially upward direction of the vehicle. In addition, in the embodiment of the invention, it will be explained that two remote shafts, which are first and second remote shafts 111 and 121, are inserted into a lever main body 101, however, the lever switch device 1 may be configured by one remote shaft.

The lever switch device 1 is schematically configured to include a body 2 provided with below-described first and second switches 66 and 67, and a lever unit 100 rotatably provided with respect to the body 2.

### Structure of Body 2

A body 1 includes a front case 3 and a back case 4, and an outer shell of the body 2 is composed of the front case 3 and the back case 4. A middle case 5 and substrates 51 and 52 are provided between the front case 3 and the back case 4. A bracket 6 is rotatably provided around a stem portion 7 between the front case 3 and the middle case 5.

A rotation direction of the bracket 6 is a direction about the rotation axis D of a lever unit 100 around the stem portion 7. For guiding a rotation of the bracket 6, a groove 8 is formed on an upper side of the middle case 5 in FIG. 3 and a convex portion 9 which is slidingly movable in the groove 8 is formed in the bracket 6. The groove 8 is a groove in a circular arc shape concentric with the stem portion 7, even though it is not illustrated.

In addition, a hollow portion 10 is formed on a right side of the bracket 6 in FIG. 3, and a terminal end portion 103 of the lever unit 100 is inserted into the hollow portion 10.

### Structure of Lever Unit 100

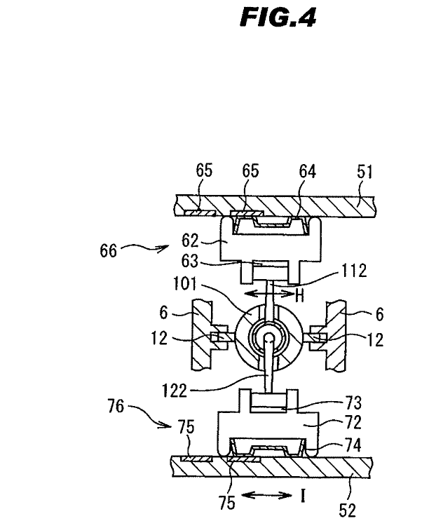

FIG. 4 is a cross sectional view showing a lever main body including a rotation axis D in the embodiment of the invention taken on line G-G of FIG. 3.

The lever unit 100 is rotatably provided around a stem portion 12 shown in FIG. 4. Rotation directions of the lever unit 100 around the stem portion 12 are an arrow E direction (rear) and an arrow F direction (forward) opposite thereto as shown in FIG. 3.

In addition, a projecting portion 14 having a hole 13 is formed at the terminal end portion 103 of the lever unit 100. A spring 15 and a moderation piece 16 are housed in the hole 13. On the other hand, a moderation wall 17 having three roots is formed in an inner part of the hollow portion 10 in the bracket 6. In the state of FIG. 3, the moderation piece 16 of the lever unit 100 is fitted with a middle root of the moderation wall 17 by a biasing force of the spring 15.

The lever unit 100 is composed of, e.g., a lever main body 101 having a cylindrical hollow section, a first remote shaft 111 integrally rotating with a first operating knob 110, a first operation portion 112 formed on the first remote shaft 111 on an opposite side of the first operating knob 110, a second remote shaft 121 integrally rotating with a second operating knob 120 and a second operation portion 122 formed on the second remote shaft 121 on an opposite side of the second operating knob 120. The lever unit 100 is a portion supported to be rotatable with respect to the body 2, and may include the above described moderation piece 16, etc.

The lever main body 101 is schematically configured to include a tip end portion 102 inserted into a second opening 110a of the first operating knob 110, a terminal end portion 103 provided with a notch 101a through which the first operation portion 112 is protruded, an insert hole 104 for inserting the first remote shaft 111, and a first opening 105 provided on a side surface so as to communicate with the insert hole 104 from the tip end portion 102 to the terminal end portion 103.

Although the first opening 105 is formed extending from the tip end portion 102 to the terminal end portion 103, it is not limited thereto, and the first opening 105 may be partially provided between the tip end portion 102 and the terminal end portion 103. In the lever main body 101, the first remote shaft 111 is incorporated rotatably, the first operating knob 110 is mounted on one end portion of the first remote shaft 111 and the first operation portion 112 is attached to another end portion so as to protrude from a notch 101a of the lever main body 101 in an upward direction of FIG. 1.

### Structure of First Remote Shaft 111

The first remote shaft 111 has an insert hole 113 therein and the second remote shaft 121 is rotatably arranged having a coaxial structure (concentrically arranged) in the insert hole 113. And then, the second operating knob 120 is mounted on one end portion of the second remote shaft 121 and the second operation portion 122 is attached to another end portion so as to protrude from a notch 101b of the lever main body 101 in a downward direction of FIG. 3.

As shown in FIG. 3 and FIG. 4, the first operation portion 112 and the second operation portion 122 are arranged on the rotation axis D of the lever main body 101 (the lever unit 100) in FIG. 3. The each tip end portion of the first operation portion 112 and the second operation portion 122 has only to be arranged at least on the rotation axis D of the lever main body 101.

### Structure of First Operating Knob 110

As shown in FIG. 1, the first operating knob 110 is schematically configured to include the second opening 110a for inserting the tip end portion 102 of the lever main body 101, and a supporting portion (first remote shaft supporting portion) 110b protruding from an inner wall of the second opening 110a toward the center thereof.

The first operating knob 110 is configured such that, as shown in FIG. 2, it is possible to rotatably support the first remote shaft 111 in the insert hole 104 of the tip end portion 102 by the supporting portion 110b when the first remote shaft 111 is inserted into the first opening 105 of the lever main body 101 and the tip end portion 102 is inserted into the second opening 110a.

As shown in FIG. 2, since the supporting portion 110b is formed having a width narrower than that of the first opening 105 in a shorter direction thereof, the rotation is allowed in the arrow E direction and the arrow F direction of the first opening 105 as shown in FIG. 3.

### Attachment of Lever Unit 100

Conventionally, when a lever having a structure similarly to the lever unit 100 is attached, it is necessary to attach the lever from an arrow A direction of FIG. 1, hence, the attachment property is not good.

However, since the lever main body 101 in the embodiment has the first opening 105 on the side surface thereof, it is possible to insert the first remote shaft 111 from the first opening 105, hence, the attachment property is good.

In addition, since it is possible to rotatably support the first remote shaft 111 on the lever main body 101 by the supporting portion 110b, it is possible to reduce components for supporting the first remote shaft 111 and the second remote shaft 121 inserted into the insert hole 113 of the first remote shaft 111, hence, reduction of the components.

### Structure of Contact Holder 62

A contact holder 62 is assembled in the front case 3, i.e. on a lower side of the substrate 51 attached to the body 2 side in FIG. 3, to be movable in a vertical direction (a direction orthogonal to the paper surface of FIG. 3). A fitting concave portion 63 is formed on a lower part of the contact holder 62 in FIG. 3 and FIG. 4, and the first operation portion 112 is fitted with the fitting concave portion 63. In the case of this configuration, the first operation portion 112 is rotationally operated when rotationally operating the first operating knob 110, and as shown in FIG. 4, the contact holder 62 reciprocates in a direction indicated by an arrow H.

In addition, a movable contact 64 is supported by the contact holder 62 on the substrate 51 side. On the other hand, a fixed contact 65 is provided on the substrate 51, and the movable contact 64 carries out a switching operation by contacting with and separating from the fixed contact 65 according to the movement of the contact holder 62. The movable contact 64 and the fixed contact 65 compose a first switch 66 provided on the body 2 side. The first switch 66 functions as, e.g., a light control switch for controlling turn-on/turn-off of a non-illustrated small lamp, etc.

### Structure of Contact Holder 72

Meanwhile, a contact holder 72 is assembled in the back case 4, i.e. on a upper side of the substrate 52 attached to the body 2 side in FIG. 3, to be movable in a vertical direction (a direction orthogonal to the paper surface of FIG. 3). A fitting concave portion 73 is formed on an upper part of the contact holder 72, and the second operation portion 122 is fitted with the fitting concave portion 73. In the case of this configuration, the second operation portion 122 is rotationally operated when rotationally operating the second operating knob 120, and as shown in FIG. 4, the contact holder 72 reciprocates in a direction indicated by an arrow I.

In addition, a movable contact 74 is supported by the contact holder 72 on the substrate 52 side. On the other hand, a fixed contact 75 is provided on the substrate 52, and the movable contact 74 carries out a switching operation by contacting with and separating from the fixed contact 75 according to the movement of the contact holder 72. The movable contact 74 and the fixed contact 75 compose a second switch 76 provided on the body 2 side. The second switch 76 functions as, e.g., a light control switch for controlling turn-on/turn-off of a non-illustrated headlamp, etc.

### Switching Operation by First and Second Operating Knobs 112 and 120

Operations in the embodiment will be explained in more detail hereinafter in conjunction with each drawing. Firstly, switching operation by the first and second operating knobs 112 and 120 will be explained.

When the first operating knob 110 is rotationally operated, the first remote shaft 111 and the first operation portion 112 rotate integrally, the contact holder 62 is reciprocated by the first operation portion 112, and it is thereby possible to carry out the switching operation of the first switch 66. Also, when the second operating knob 120 is rotationally operated, the second remote shaft 121 and the second operation portion 122 rotate integrally, the contact holder 72 is reciprocated by the second operation portion 122, and it is thereby possible to carry out the switching operation of the second switch 76.

### Motion of Lever Switch Device 1

In addition, a third switch for carrying out a switching operation according to the rotation of the bracket 6, and fourth and fifth switches for carrying out switching operations according to the rotation of the lever unit 100 in the arrow E and F directions in FIG. 3 are provided inside the body 2, even though none of them are illustrated. The third switch functions as, e.g., a switch for controlling a turn signal, the fourth switch functions as, e.g., a switch for carrying out a dimmer control of a headlamp and the fifth switch functions as, e.g., a switch for controlling passing.

When the lever main body 101 is rotationally operated about the rotation axis D around the stem portion 7 shown in FIG. 3, the lever main body 101 is rotationally moved with the bracket 6 around the stem portion 7 of the bracket 6. As a result, the non-illustrated third switch is operated and switch control of the turn signal is carried out. As for the rotational operation of the lever main body 101, moderation feeling is also imparted by a well-known moderation mechanism which is not illustrated.

Meanwhile, when the lever main body 101 is rotationally operated in a direction indicated by the arrow E (rear) in FIG. 3, the lever main body 101 rotates in the arrow E direction around the stem portion 12 shown in FIG. 4. As a result, the non-illustrated fourth switch is operated and the dimmer control of the headlamp is carried out. At this time, the moderation piece 16 crosses over a crest on an upper side in FIG. 3 from the middle root in the moderation wall 17 while compressing the spring 15, and is engaged with a root on its upper side. The moderation feeling is imparted to the operation of the lever main body 101 in the arrow E direction by this movement.

Meanwhile, when the lever main body 101 is rotationally operated in a direction indicated by the arrow F (forward), the lever main body 101 rotates in the arrow F direction around the stem portion 12 shown in FIG. 4. As a result, the non-illustrated fifth switch is operated and the passing control is carried out. At this time, the moderation piece 16 moves to a lower crest in FIG. 3 from the middle root in the moderation wall 17 while compressing the spring 15, and by the resistance thereof, the moderation feeling is imparted to the rotational operation of the lever main body 101 in a forward direction.

In case of this configuration, when the operation by a user is released at the moment that the moderation feeling is imparted, the lever main body 101 automatically returns as the moderation piece 16 is restored to the original root by the spring 15. On the other hand, after operating the aforementioned lever main body 101 backwards, the moderation piece 16 returns to the original root from the upper root in FIG. 3 crossing over the lower crest by manually returning the lever main body 101.

### Effect of the Embodiment

(1) According to the lever switch device 1 in the embodiment of the invention, since the first opening 105 is provided in the lever main body 101, it is possible to easily attach the first remote shaft 111 to the lever main body 101 and to improve the attachment property.

(2) According to the lever switch device 1 in the embodiment of the invention, since it is possible to rotatably support the first remote shaft 111 in the lever main body 101 by the supporting portion 110b of the first operating knob 110, it is possible to reduce the number of components, thereby reducing the cost.

(3) According to the lever switch device 1 in the embodiment of the invention, although the first remote shaft 111 and the second remote shaft 121 are rotatably arranged in the lever main body 101 having a coaxial structure, a remote shaft arranged in the lever main body 101 having the coaxial structure may be only the first remote shaft 111, or may be three or more remote shafts. In other words, by the rotational operations of three or more operating knobs, it is possible to drive three or more remote shafts and operation portions each corresponding thereto, and it is also possible to operate three or more switches by three or more operating knobs.

It should be noted that the present invention is not intended to be limited to the above-mentioned embodiment, and the various kinds of changes thereof can be implemented by those skilled in the art without departing from or without modifying the technical idea of the present invention.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. A lever switch device, comprising:
a lever main body comprising an insert hole communicating from a tip end portion to a terminal end portion and a first opening provided on a side surface so as to at least partially communicate with the insert hole between the tip end portion and the terminal end portion, the lever main body being rotatably supported by a body around a predetermined rotation center axis; and
a first remote shaft rotatably arranged through the first opening of the lever main body, and comprising a first operating knob at one end portion and a first operation portion at another end portion for operating an operational object by a rotational operation of the first operating knob.

2. The lever switch device according to claim 1, wherein the first operating knob comprises a second opening for inserting the tip end portion of the lever main body and a first remote shaft supporting portion protruding from an inner wall of the second opening; and
the first remote shaft is rotatably supported with respect to the lever main body by the first remote shaft supporting portion.

3. The lever switch device according to claim 1, wherein the lever main body comprises a tip end portion inserted into the second opening of the first operating knob, a terminal end portion provided with a notch through which the first operation portion is protruded, an insert hole for inserting the first remote shaft, and the first opening provided on a side surface so as to communicate with the insert hole from the tip end portion to the terminal end portion.

4. The lever switch device according to claim 1, wherein first remote shaft is rotatably incorporated in the lever main body;
the first operating knob is mounted at an end portion of the first remote shaft; and
the first operation portion is attached in a protruding condition at another end portion of the first remote shaft.

5. The lever switch device according to claim 1, wherein, when the first remote shaft is inserted into the first opening of the lever main body and the tip end portion is inserted into the second opening, the supporting portion rotatably supports the first remote shaft in the insert hole of the tip end portion.

6. A lever switch device, comprising:
a lever main body comprising an insert hole communicating from a tip end portion to a terminal end portion and a first opening provided on a side surface so as to at least partially communicate with the insert hole between the tip end portion and the terminal end portion, the lever main body being rotatably supported by a body around a predetermined rotation center axis;
a first remote shaft rotatably arranged through the first opening of the lever main body, and comprising a first operating knob at one end portion and a first operation portion at another end portion for operating an operational object by a rotational operation of the first operating knob, the first operating knob comprising a second opening for inserting the tip end portion of the lever main body and a first remote shaft supporting portion protruding from an inner wall of the second opening; and
a second remote shaft rotatably arranged in the insert hole of the lever main body having a coaxial structure with the first remote shaft, and comprising a second operating knob at one end portion and a second operation portion at another end portion for operating an operational object by a rotational operation of the second operating knob,
wherein first remote shaft is rotatably supported with respect to the lever main body by the first remote shaft supporting portion.

7. The lever switch device according to claim 6, wherein a lever unit comprises the lever main body having a cylindrical hollow sectional shape, the first remote shaft integrally rotating with the first operating knob, the first operation portion formed on the first remote shaft on the opposite side of the first operating knob, the second remote shaft integrally rotating with the second operating knob, and the second operation portion formed on the second remote shaft on the opposite side of the second operating knob.

8. The lever switch device according to claim 6, wherein the first remote shaft comprises an insert hole; and
the second remote shaft is rotatably arranged in the insert hole having a coaxial structure.

9. The lever switch device according to claim 6, wherein the second operating knob is mounted at an end portion of the second remote shaft; and
the second operation portion is attached in a protruding condition at another end portion of the second remote shaft.

10. The lever switch device according to claim 6, wherein the first and second operation portions are arranged on a rotation axis of the lever main body; and
each tip end portion of the first and second operation portions is arranged at least on the rotation axis of the lever main body.
